(19) United States
(12) Patent Application Publication
(10) Pub. No.: US 2021/0382868 A1
(43) Pub. Date: Dec. 9, 2021

(54) DATA MANAGEMENT SYSTEM

(71) Applicant: Rahaman Javid Ur, Irving, TX (US)

(72) Inventor: Rahaman Javid Ur, Irving, TX (US)

(21) Appl. No.: 17/411,418

(22) Filed: Aug. 25, 2021

Related U.S. Application Data
(60) Provisional application No. 63/166,948, filed on Mar. 26, 2021.

(51) Int. Cl. G06F 16/22; G06F 21/60

(52) U.S. Cl. CPC G06F 16/2272; G06Q 50/26; G06F 21/602

(57) ABSTRACT

A data management system and method for data management at enterprise levels. The data management system can add a crypto tag and a geo tag to the data blocks for tracking, safety, and analytics.

### CROSS-REFERENCE TO RELATED APPLICATIONS

This application claims priority to the U.S. provisional patent application Ser. No. 63/166,948, filed on Mar. 26, 2021, which is incorporated herein by reference in its entirety.

### FIELD OF INVENTION

The present invention relates to data management on an enterprise level with the highest security and reliability, and more particularly, the present invention relates to data management including geotagging and cryptography.

### BACKGROUND

Public records management is an important process in government organizations. For public records, it is essential to take all safeguards against any kind of tampering with the records. Moreover, the records are generally duplicated, wherein one copy is kept as a backup. Government agencies typically spend a huge number of resources, efforts, and money in processing a large number of documents generated daily. Public records management is generally complex being requiring a high degree of security and many records may also require confidentially, while others may be open to the public.

At present, the current records management systems employed by the government agencies are based on a variety of methods and there is no one standard process. Moreover, most government agencies are adopting electronic documents storage and sharing. However, both traditional paper-based records and digital records are susceptible to tampering, falsification, and deletion. Digital records are particularly susceptible to hacking, cyber intrusions, and cyber threats. Besides the external sources, the records can also be tampered by someone internally in an organization, for example, to hide facts, etc. Many of the public records have a legal weightage and any tapering with such public records can have serious outcomes for many.

Thus, a long-term and unsolved desire is there for a data management system that is immune to tampering and can be easily replicated to different government organizations.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention, therefore, is directed to a data management system and method that can prevent both internal and external tempering of the data.

It is another object of the present invention that the data management system can be easily adapted to the needs of different government agencies.

It is still another object of the present invention that the data management system can be standardized.

It is yet another object of the present invention that the data management system can be cost-effective.

It is still a further object of the present invention that classified information can be securely stored and accessed.

It is yet a further object of the present invention that the data management system can prevent the unauthorized creation of a record.

It is an additional object of the present invention that the data management system can provide for nonrepudiation functionality.

It is still an additional object of the present invention that the authorship of records can be ascertained by using cryptographic methods.

It is yet an additional object of the present invention that the data management system can also provide for government public asset tracking.

In one aspect, disclosed is a data management system that can include a processor and a memory coupled through a system bus, the memory can include: a database module, which upon execution by the processor, receives data blocks; a crypto module, which upon execution by the processor, adds a crypto tag to the data blocks; and a geotag module, which upon execution by the processor, adds a geotag to the data blocks.

In one aspect, disclosed is a method for data management at an enterprise level, the method implemented within a data management system, the data management comprises a processor and a memory coupled through a system bus, the method comprising the steps of: receiving, by a database module implemented within the data management system and upon execution by the processor, a plurality of data blocks; adding, by a crypto module implemented within the data management system and upon execution by the processor, a crypto tag to the plurality of data blocks; and adding, by a geo tag module implemented within the data management system and upon execution by the processor, a geo tag to the plurality of data blocks. The geo tag includes location geographical coordinates.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows random data blocks in a database table, according to an exemplary embodiment of the present invention.

FIG. 2 defragmentation of the data blocks in a database table, according to an exemplary embodiment of the present invention.

FIG. 3 shows the segmentation of the data blocks, according to an exemplary embodiment of the present invention.

FIG. 4 shows a user session, according to an exemplary embodiment of the present invention.

FIG. 5 shows user data tagging inside the core database, according to an exemplary embodiment of the present invention.

FIG. 6 shows a system architecture, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a data management system based on a low-cost next-generation database platform for government public asset tracking to avoid duplication of data, internal and external data tampering, and to maintain tight security and compliance. The disclosed data management system can be scalable, in-memory grids using common compute services across all government and commercial cloud providers. The data management system can provide for hybrid data store with mapping, wherein blockchain and cryptographic technology can be used to prevent any kind of internal and external tampering with records and nonrepudiation.

The disclosed data management system can be easily adapted to different data types across the different government and commercial agencies. All the activities related to the creation and management of data can be tracked and subjected to usage analytics. Preferably, the tracking of data can be achieved by geo-tagging the data blocks i.e., location coordinates can be embedded in metadata of the data blocks. The blocks can be stored in a blockchain-compatible database and tracked by a public blockchain ledger. Blockchain-based tracking can be provided for supply chain data. The data management system can also include XML integration tools for data integrations that can make both automated storage and retrieval of data. Other data types that can be handled by the data management system can include IOT data store with in-memory low latency cache processing.

The disclosed data management system can provide for a hybrid database approach having dual integrity with ACID for SQL-compatible data structures. ACID compliance of databases is known in the art and has become a standard in many sectors for ensuring data integrity, such as banking. To be ACID compliant, a database should possess four properties: atomicity, consistency, isolation, and durability. Atomicity means that a transaction must exhibit an “all or nothing” behavior. Either all of the instructions within the transaction happen successfully, or none of them happen. Atomicity preserves the “completeness” of the business process. Consistency refers to the state of the data both before and after the transaction is executed. A transaction maintains the consistency of the state of the data. In other words, after running a transaction, all data in the database is “correct.” Isolation means that transactions can run at the same time. any transactions running in parallel have the illusion that there is no concurrency. In other words, it appears that the system is running only a single transaction at a time. No other concurrent transaction has visibility to the uncommitted database modifications made by any other transactions. To achieve isolation, a locking mechanism is required. Durability refers to the impact of an outage or a failure on a running transaction. a durable transaction will not impact the state of data if the transaction ends abnormally. In other words, the data survives any failures.

A standardized method of data management using the disclosed data management system can ensure easy access to the data to facilitate the provision, de-provision, changes to data access methods. Geo Tagging of data for global compliances, database tables can have primary, secondary, shadow copies with fully encrypted keys for data blocks for geo access policies. Data blocks can be crypto signed to ensure authorship and preventing any tampering with the data later but can only be copied to other sources with the same or different file names.

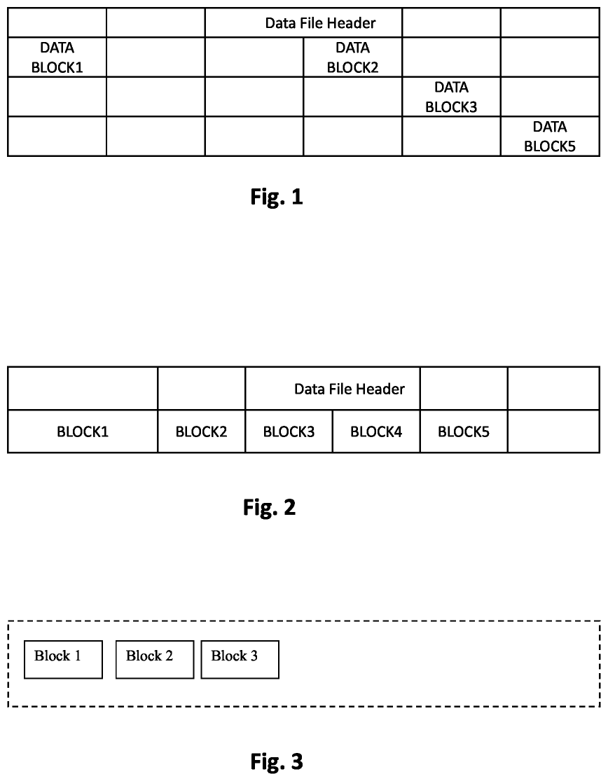

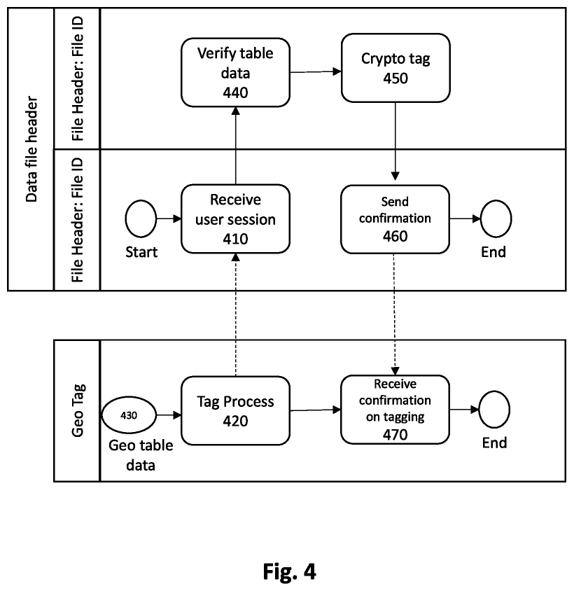

Referring to FIG. 1, which illustrates how data can be randomly loaded initially when the data operation starts as data blocks. The data blocks get copies in real-time while the database operates and shadows to shadow blocks and fragmentation gets resolved automatically, as shown in FIG. 2. The data can be automatically segmented when the database is idle without any change to the data, as shown in FIG. 3. It is to be understood that the data operation illustrated in FIG. 1-3 are common in database management. FIG. 4 shows how data can be processed during a user session. At block 410, a user session can be received by the disclosed data management system. To the user session, can be associated a tag process, at block 420, linked to the geo table data, shown by block 430. Block 440 can verify the table data, and block 450 can provide for crypto tagging the data blocks. Block 460 can make a confirmation and the process can end. Block 470 can make additional confirmation of the tagging.

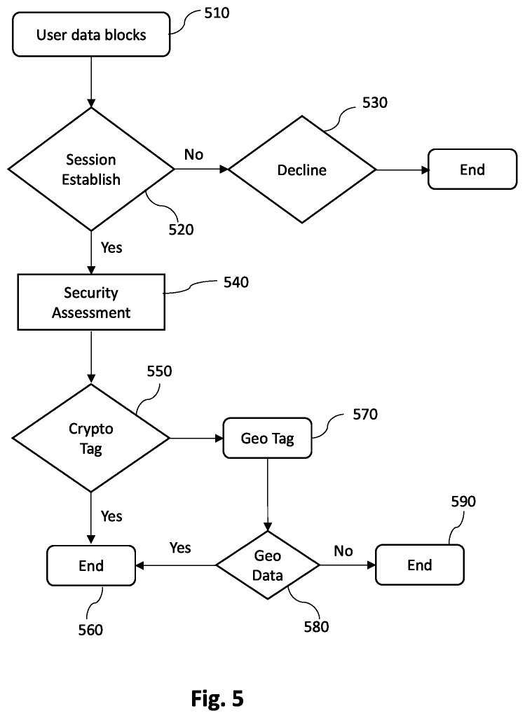

Referring to FIG. 5, which is a flowchart showing the user data tagging inside the core database. First for user data blocks at step 510, a check can be made if a session can be established, at step 520. If no session can be established at step 520, the process can be declined, at step 530, and the process can end. In case, the session can be established, a security assessment can be made at step 540. The presence of crypto tags in the user data block can be checked at step 550. In case, the crypto tag is present, the process can end at step 560. Otherwise, a geotag can be provided at step 570. The presence of geodata can then be checked at step 580. If geodata can be found, the process can end at step 560, else the process can end at step 590.

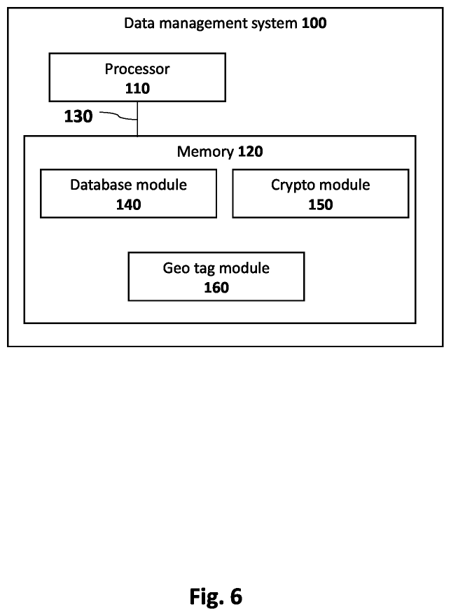

Referring to FIG. 6 which shows an embodiment of the data management system 100 that can include a processor 110 and a memory 120 coupled through a system bus 130. The memory can include a database module 140 that upon execution by the processor can receive data blocks and perform data organization and defragmentation operations on the data blocks. The memory 120 can also include a crypto module 150 that can add the crypto tag to the data blocks. Another, geo tag module 160 in the memory 120 can add a geo tag to the data blocks, such as geographical coordinates in a user session.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A data management system comprising a processor and memory, the memory coupled to the processor through a system bus, the memory comprises:
a database module, which upon execution by the processor, receives data blocks;
a crypto module, which upon execution by the processor, adds a crypto tag to the data blocks; and
a geotag module, which upon execution by the processor, adds a geotag to the data blocks.

2. A method for data management at an enterprise level, the method implemented within a data management system, the data management comprises a processor and a memory coupled through a system bus, the method comprising the steps of:
receiving, by a database module implemented within the data management system and upon execution by the processor, a plurality of data blocks;
adding, by a crypto module implemented within the data management system and upon execution by the processor, a crypto tag to the plurality of data blocks; and
adding, by a geo tag module implemented within the data management system and upon execution by the processor, a geo tag to the plurality of data blocks.

3. The method according to claim 2, wherein the geo tag includes location geographical coordinates.
